(19) United States
(12) Patent Application Publication
(10) Pub. No.: US 2021/0394756 A1
(43) Pub. Date: Dec. 23, 2021

(54) SYSTEM AND METHOD FOR PREDICTIVE VEHICLE LAUNCH

(71) Applicant: GM GLOBAL TECHNOLOGY OPERATIONS LLC, DETROIT, MI (US)

(72) Inventors: Amanpal S. Grewal, Novi, MI (US); Dmitriy Feldman, West Bloomfield, MI (US); Robert C. Baraszu, Livonia, MI (US); Daniel R. Kraft, Berkley, MI (US); Benjamin T. Llewellyn, Ypsilanti, MI (US)

(21) Appl. No.: 16/905,510

(22) Filed: Jun. 18, 2020

(51) Int. Cl. B60W 30/16; B60W 30/14

(52) U.S. Cl. CPC B60W 30/16; B60W 2420/42; B60W 2554/404; B60W 30/143

(57) ABSTRACT

One general aspect includes a system to commence host vehicle movement upon being stopped behind a target vehicle, the system includes a memory configured to include one or more executable instructions and a processor configured to execute the executable instructions, where the executable instructions enable the processor to: detect the target vehicle as being stopped along a route; cause the host vehicle to stop at a first distance from the target vehicle; detect a transition of one or more brake lights of the target vehicle from an ON state to an OFF state; and after the one or more brake lights are detected to transition from the ON state to the OFF state, cause the host vehicle to move at a slow speed in the direction of the target vehicle.

The operation of modern vehicles is becoming more automated (i.e. able to provide driving control with less and less driver intervention). Vehicle automation has been categorized into numerical levels ranging from zero, corresponding to no automation with full human control, to five, corresponding to full automation with no human control. Various advanced driver-assistance systems (ADAS) provide features such as, for example, cruise control, adaptive cruise control, and parking assistance. In particular, the adaptive cruise control feature generally uses sensors to detect lane markers and other roadway indicators to generate a motion path for the vehicle to follow to remain within a vehicle lane on the roadway. Moreover, when this adaptive cruise control feature provides Full Speed Range Adaptive Cruise Control or “FSRACC” functionality, upon the detection of another vehicle being stopped on the roadway, the feature will enable the vehicle to come to a complete stop behind this stopped third-party vehicle and subsequently cause the vehicle to resume motion after the third-party vehicle is removed from the vehicle's path.

Current FSRACC technology relies solely on the stopped third-party vehicle's sensed position and sensed velocity to know when to activate the brake control to cause vehicle relaunch. However, reactivating vehicle movement in this manner can also allow for numerous delays in the vehicle movement related to discrepancies in stop-start timing, brake release, and vehicle relaunch acceleration. It is therefore desirable to use indicia on the third-party vehicle to assist the adaptive cruise control to begin vehicle creep in anticipation of a full vehicle relaunch so as to reduce the likelihood of vehicle launch delay. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system to commence host vehicle movement upon being stopped behind a target vehicle, the system includes a memory configured to include one or more executable instructions and a processor configured to execute the executable instructions, where the executable instructions enable the processor to: detect the target vehicle as being stopped along a route; cause the host vehicle to stop at a first distance from the target vehicle; detect a transition of one or more brake lights of the target vehicle from an ON state to an OFF state; and after the one or more brake lights are detected to transition from the ON state to the OFF state, cause the host vehicle to move at a slow speed in the direction of the target vehicle. Other embodiments of this aspect include corresponding computer systems, apparatus, and computer programs recorded on one or more computer storage devices, each configured to perform the actions of the methods.

Implementations may include one or more of the following features. The system where the transition of the one or more brake lights of the target vehicle from the ON state to the OFF state is detected based on an output from one or more cameras installed on the host vehicle. The system where the executable instructions further enable the processor to: before the one or more brake lights are detected to transition from the ON state to the OFF state, verify a location of the target vehicle in relation to the location of the host vehicle; and based on the verification of the target vehicle location, cause the host vehicle to move at a slow speed in the direction of the target vehicle. The system where the executable instructions further enable the processor to, before the one or more brake lights are detected to transition from the ON state to the OFF state, transition an engine of the host vehicle to an inactive state. The system where the executable instructions further enable the processor to, after the one or more brake lights are detected to transition from the ON state to the OFF state, transition an engine of the host vehicle to an active state. The system where the executable instructions further enable the processor to, while the host vehicle moves at the slow speed, determine whether the host vehicle has arrived at a second distance from the target vehicle; and when the host vehicle is determined to have arrived at the second distance, cause the host vehicle to stop moving at the slow speed. The system where the executable instructions further enable the processor to, when the host vehicle is determined to be beyond the second distance from the target vehicle, determine whether it is improbable the host vehicle will arrive at the second distance; and, when it is determined to be improbable the host vehicle will arrive at the second distance, commence vehicle movement at a driver-selected rate of speed. Implementations of the described techniques may include hardware, a method or process, or computer software on a computer-accessible medium.

One general aspect includes a method to commence host vehicle movement upon being stopped behind a target vehicle, the method including: detecting the target vehicle as being stopped along a route; causing the host vehicle to stop at a first distance from the target vehicle; detecting a transition of one or more brake lights of the target vehicle from an ON state to an OFF state; and after the one or more brake lights are detected to transition from the ON state to the OFF state, causing the host vehicle to move at a slow rate of speed in the direction of the target vehicle. Other embodiments of this aspect include corresponding computer systems, apparatus, and computer programs recorded on one or more computer storage devices, each configured to perform the actions of the methods.

Implementations may include one or more of the following features. The method where the transition of the one or more brake lights of the target vehicle from the ON state to the OFF state is detected based on an output from one or more cameras installed on the host vehicle. The method further including, before the one or more brake lights are detected to transition from the ON state to the OFF state, verifying a location of the target vehicle in relation to the location of the host vehicle; and based on the verification of the target vehicle location, causing the host vehicle to move at a slow rate of speed in the direction of the target vehicle. The method further including, before the one or more brake lights are detected to transition from the ON state to the OFF state, transitioning an engine of the host vehicle to an inactive state. The method further including, after the one or more brake lights are detected to transition from the ON state to the OFF state, transitioning an engine of the host vehicle to an active state. The method further including, while the host vehicle moves at the slow rate of speed, determining whether the host vehicle has arrived at a second distance from the target vehicle; and, when the host vehicle is determined to have arrived at the second distance, causing the host vehicle to stop moving at the slow rate of speed. The method further including, when the host vehicle is determined to be beyond the second distance from the target vehicle, determining whether it is improbable the host vehicle will arrive at the second distance; and, when it is determined to be improbable for the host vehicle to arrive at the second distance, commencing vehicle movement at a driver-selected rate of speed. Implementations of the described techniques may include hardware, a method or process, or computer software on a computer-accessible medium.

One general aspect includes a non-transitory machine-readable medium having stored thereon executable instructions adapted to commence host vehicle movement upon being stopped behind a target vehicle, which when provided to a processor and executed thereby, causes the processor to: detect the target vehicle as being stopped along a route; cause the host vehicle to stop at a first distance from the target vehicle; detect a transition of one or more brake lights of the target vehicle from an ON state to an OFF state; and after the one or more brake lights are detected to transition from the ON state to the OFF state, cause the host vehicle to move at a slow rate of speed in the direction of the target vehicle. Other embodiments of this aspect include corresponding computer systems, apparatus, and computer programs recorded on one or more computer storage devices, each configured to perform the actions of the methods.

Implementations may include one or more of the following features. The non-transitory machine-readable medium further including, before the one or more brake lights are detected to transition from the ON state to the OFF state, verify a location of the target vehicle in relation to the location of the host vehicle; and based on the verification of the target vehicle location, cause the host vehicle to move at a slow rate of speed in the direction of the target vehicle. The non-transitory machine-readable medium further including, before the one or more brake lights are detected to transition from the ON state to the OFF state, transition an engine of the host vehicle to an inactive state. The non-transitory machine-readable medium further including, after the one or more brake lights are detected to transition from the ON state to the OFF state, transition an engine of the host vehicle to an active state. The non-transitory machine-readable medium further including, while the host vehicle moves at the slow rate of speed, determine whether the host vehicle has arrived at a second distance from the target vehicle; and, when the host vehicle is determined to have arrived at the second distance, cause the host vehicle to stop moving at the slow rate of speed. The non-transitory machine-readable medium further including, when the host vehicle is determined to be beyond the second distance from the target vehicle, determine whether it is improbable the host vehicle will arrive at the second distance; and, when it is determined to be improbable the host vehicle will arrive at the second distance, commence vehicle movement at a driver-selected rate of speed. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

FIG. 1 is a block diagram depicting an exemplary embodiment of an electronics system capable of utilizing the system and method disclosed herein;

FIG. 2 is an exemplary flow chart for the utilization of exemplary system and method aspects disclosed herein;

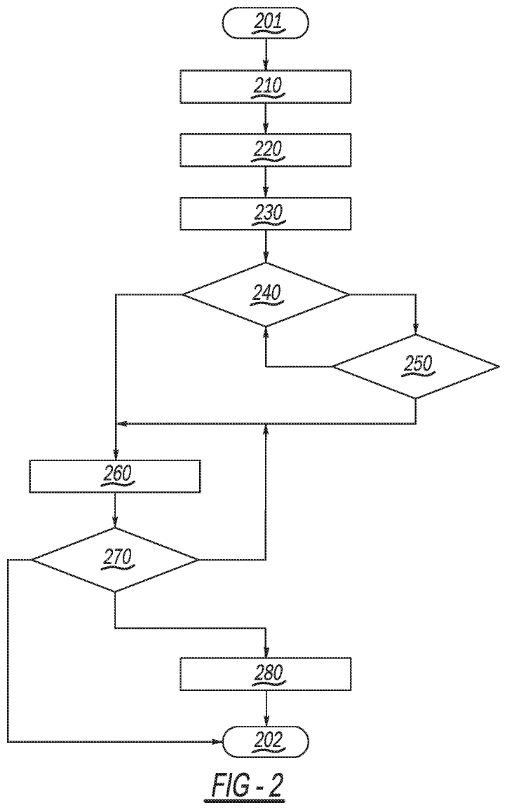

FIG. 3A is an illustrative aspect of the process flow of FIG. 2; and

FIG. 3B is another illustrative aspect of the process flow of FIG. 2.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

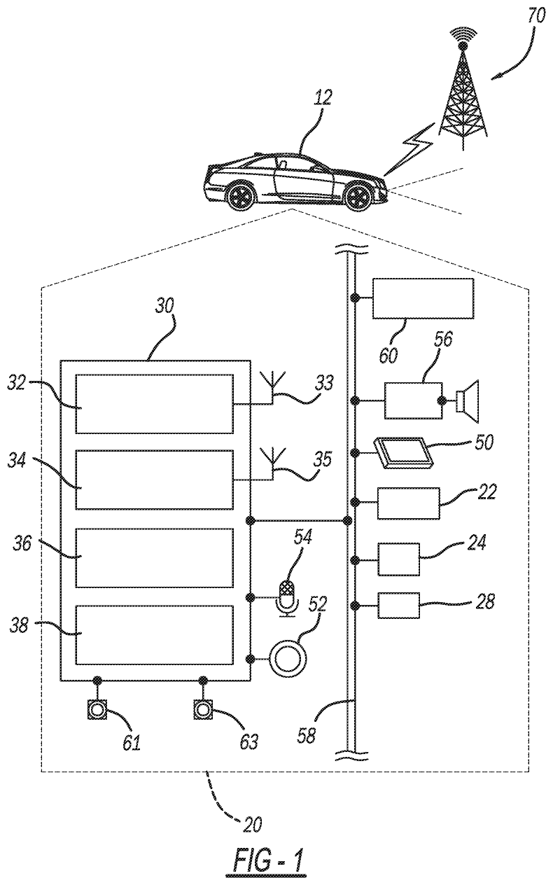

With reference to FIG. 1, vehicle 12 is depicted in the illustrated embodiment as a sports utility vehicle (SUV), but it should be appreciated that any other vehicle including motorcycles, trucks, passenger sedan, recreational vehicles (RVs), marine vessels, aircraft including unmanned aerial vehicles (UAVs), etc., can also be used. In certain embodiments, vehicle 12 may include a power train system with multiple generally known torque-generating devices including, for example, an engine. The engine may be an internal combustion engine that uses one or more cylinders to combust fuel, such as gasoline, in order to propel vehicle 12. The power train system may alternatively include numerous electric motors or traction motors that convert electrical energy into mechanical energy for propulsion of vehicle 12. The power train system may also be a start-stop system that will cause the engine to automatically transition to an inactive state (from an active state) when the vehicle is stopped so as to reduce the amount of idling time and thus to reduce fuel consumption and emissions.

Some of the vehicle electronics 20 are shown generally, in FIG. 1 and includes a global navigation satellite system (GNSS) receiver 22, a body control module or unit (BCM) 24, and other vehicle system modules (VSMs) 28, a telematics unit 30, vehicle-user interfaces 50-58, and onboard computer 60. Some or all of the different vehicle electronics may be connected for communication with each other via one or more communication busses, such as communications bus 58. The communications bus 58 provides the vehicle electronics with network connections using one or more network protocols and can use a serial data communication architecture. Examples of suitable network connections include a controller area network (CAN), a media-oriented system transfer (MOST), a local interconnection network (LIN), a local area network (LAN), and other appropriate connections such as Ethernet or others that conform with known ISO, SAE, and IEEE standards and specifications, to name but a few. In other embodiments, a wireless communications network that uses short-range wireless communications (SRWC) to communicate with one or more VSMs of the vehicle can be used. In one embodiment, the vehicle 12 can use a combination of a hardwired communications bus 58 and SRWCs. The SRWCs can be carried out using the telematics unit 30, for example.

The vehicle 12 can include numerous vehicle system modules (VSMs) as part of vehicle electronics 20, such as the GNSS receiver 22, BCM 24, telematics unit 30 (vehicle communications system), vehicle-user interfaces 50-56, and onboard computer 60, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 is hardwire connected by communications bus 58 to the other VSMs including the telematics unit 30. Moreover, each of the VSMs can include and/or be communicatively coupled to suitable hardware that enables intra-vehicle communications to be carried out over the communications bus 58; such hardware can include, for example, bus interface connectors and/or modems. One or more VSMs 28 may periodically or occasionally have their software or firmware updated and, in some embodiments, such vehicle updates may be over the air (OTA) updates that are received from a remote computer or facility via a land network (not shown) and telematics unit 30. As is appreciated by those skilled in the art, the above-mentioned VSMs are only examples of some of the modules that may be used in vehicle 12, as numerous others are also possible. It should also be appreciated that these VSMs can otherwise be known as electronic control units, or ECUs. Examples of known VSMs 28 are a throttle controller, brake controller, and a steering controller. As follows, the throttle controller electronically or mechanically controls the vehicle's throttle, brake controller electronically or mechanically controls the vehicle's brakes, and the steering controller electronically or mechanically controls the vehicle's steering.

Global navigation satellite system (GNSS) receiver 22 receives radio signals from a constellation of GNSS satellites (not shown). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites (not shown). And, in another example, GNSS receiver 22 can be a BDS receiver that receives a plurality of GNSS (or BDS) signals from a constellation of GNSS (or BDS) satellites. The GNSS received can determine a current vehicle location based on reception of a plurality of GNSS signals from the constellation of GNSS satellites. The vehicle location information can then be communicated to the telematics unit 30, or other VSMs, such as the onboard computer 60. In one embodiment (as shown in FIG. 1), the telematics unit 30 and/or a telematics unit can be integrated with the GNSS receiver 22 so that, for example, the GNSS receiver 22 and the telematics unit 30 (or the wireless communications device) are directly connected to one another as opposed to being connected via communications bus 58. In other embodiments, the GNSS receiver 22 is a separate, standalone module or there may be a GNSS receiver 22 integrated into the telematics unit 30 in addition to a separate, standalone GNSS receiver connected to telematics unit 30 via communications bus 58.

Body control module (BCM) 24 can be used to control various VSMs 28 of the vehicle, as well as obtain information concerning the VSMs, including their present state or status, as well as sensor information. The BCM 24 is shown in the exemplary embodiment of FIG. 1 as being electrically coupled to the communication bus 58. In some embodiments, the BCM 24 may be integrated with or part of a center stack module (CSM) and/or integrated with telematics unit 30 or the onboard computer 60. Or, the BCM may be a separate device that is connected to other VSMs via bus 58. The BCM 24 can include a processor and/or memory, which can be similar to processor 36 and memory 38 of telematics unit 30, as discussed below. The BCM 24 may communicate with telematics unit 30 and/or one or more vehicle system modules, such as an engine control module (ECM), audio system 56, or other VSMs 28; in some embodiments, the BCM 24 can communicate with these modules via the communications bus 58. Software stored in the memory and executable by the processor enables the BCM 24 to direct one or more vehicle functions or operations including, for example, controlling central locking, controlling an electronic parking brake, power sun/moon roof, the vehicle's head lamps, air conditioning operations, power mirrors, controlling the vehicle primary mover (e.g., engine, primary propulsion system), and/or controlling various other vehicle system modules (VSMs).

Telematics unit 30 is capable of communicating data via SRWC through use of SRWC circuit 32 and/or via cellular network communications through use of a cellular chipset 34, as FIG. 1 depicted in the illustrated embodiment. The telematics unit 30 can provide an interface between various VSMs of the vehicle 12 and one or more devices external to the vehicle 12, such as one or more networks or systems at a remote call center (e.g., ON-STAR by GM). This enables the vehicle to communicate data or information with remote systems at a remote call center (not shown).

In at least one embodiment, the telematics unit 30 can also function as a central vehicle computer that can be used to carry out various vehicle tasks. In such embodiments, the telematics unit 30 can be integrated with the onboard computer 60 such that the onboard computer 60 and the telematics unit 30 are a single module. Or, the telematics unit 30 can be a separate central computer for the vehicle 12 in addition to the onboard computer 60. Also, the wireless communications device can be incorporated with or a part of other VSMs, such as a center stack module (CSM), body control module (BCM) 24, an infotainment module, a head unit, a telematics unit, and/or a gateway module. In some embodiments, the telematics unit 30 is a standalone module, and can be implemented as an OEM-installed (embedded) or aftermarket device that is installed in the vehicle.

Telematics unit 30 can also, for example, provide vehicle 12 with certain known advanced driver-assistance system (ADAS) features, which can provide Level Two and Level Three autonomous system functionality such that vehicle 12 can handle minor dynamic driving tasks but still require intervention from a human and may, in certain situations, require assistance from a human. Examples of known ADAS features include adaptive cruise control (e.g., Full Speed Range Adaptive Cruise Control or “FSRACC”) and lane assist systems, which control certain aspects of the driving experience despite a human having their hands physically on the steering wheel. As is known, adaptive cruise control functionality is one that will cause vehicle 12 to move at a constant rate of speed while still attempting to maintain at least a predetermined distance between the vehicle and objects in a path of the vehicle. For instance, while traveling along a path, vehicle 12 will automatically adjust its speed to maintain a safe distance from third-party vehicles (target vehicles) traveling ahead of it. Moreover, if a third-party vehicle ahead of vehicle 12 slows to a halt, then vehicle 12 will also slow to a halt and stop at a certain distance away from the third-party vehicle (e.g., four (4) meters).

In the illustrated embodiment, telematics unit 30 includes, the SRWC circuit 32, the cellular chipset 34, a processor 36, memory 38, SRWC antenna 33, and antenna 35. The telematics unit 30 can be configured to communicate wirelessly according to one or more SRWC protocols such as any of the Wi-Fi™, WiMAX™, Wi-Fi™ Direct, other IEEE 802.11 protocols, ZigBee™ Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. And, in some embodiments, the telematics unit 30 can be configured to communicate using IEEE 802.11p such that the vehicle can carry out vehicle-to-vehicle (V2V) communications, or vehicle-to-infrastructure (V2I) communications with infrastructure systems or devices, such as at a remote call center. And, in other embodiments, other protocols can be used for V2V or V2I communications.

The SRWC circuitry 32 enables the telematics unit 30 to transmit and receive SRWC signals, such as BLE signals. The SRWC circuit can allow the telematics unit 30 to connect to another SRWC device (e.g., a smart phone, target vehicle 99, etc.). Additionally, in some embodiments, the telematics unit 30 contains a cellular chipset 34 thereby allowing the device to communicate via one or more cellular protocols, such as those used by cellular carrier system 70, through antenna 35. In such a case, the telematics unit 30 is user equipment (UE) that can be used to in carry out cellular communications via cellular carrier system 70.

Antenna 35 is used for communications and is generally known to be located throughout vehicle 12 at one or more locations external to the telematics unit 30. Using antenna 35, telematics unit 30 may enable the vehicle 12 to be in communication with one or more local or remote networks (e.g., one or more networks at a remote call center or server) via packet-switched data communication. This packet switched data communication may be carried out through use of a non-vehicle wireless access point or cellular system that is connected to a land network via a router or modem. When used for packet-switched data communication such as TCP/IP, the communications device 30 can be configured with a static Internet Protocol (IP) address or can be set up to automatically receive an assigned IP address from another device on the network such as a router or from a network address server.

Packet-switched data communications may also be carried out via use of a cellular network that may be accessible by the telematics unit 30. Communications device 30 may, via cellular chipset 34, communicate data over wireless carrier system 70. In such a scenario, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the telematics unit 30 to provide a wide variety of services. For instance, in one embodiment, the processor 36 can execute programs or process data to carry out at least a part of the method discussed herein. Memory 38 may include any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. In one embodiment, the telematics unit 30 also includes a modem for communicating information over the communications bus 58.

Vehicle electronics 20 also includes a number of vehicle-user interfaces that provide vehicle occupants with a means of providing and/or receiving information, including visual display 50, pushbutton(s) 52, microphone 54, audio system 56, one or more external cameras 61, and a lidar 63. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, and/or control input. Audio system 56 provides audio output to a vehicle occupant and can be a dedicated, stand-alone system or part of the primary vehicle audio system. According to one embodiment, audio system 56 is operatively coupled to both vehicle bus 58 and an entertainment bus (not shown) and can provide AM, FM and satellite radio, CD, DVD, and other multimedia functionality. This functionality can be provided in conjunction with or independent of an infotainment module. Microphone 54 provides audio input to the telematics unit 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display 50 is preferably a touch-screen graphics display and can be used to provide a multitude of input and output functions. Display 50 can be a touch screen on the instrument panel, a heads-up display reflected off of the windshield, a video projector that projects images onto the windshield from the vehicle cabin ceiling, or some other display. For example, display 50 can be the touch screen of the vehicle's infotainment module at the center console of the vehicle's interior. Various other vehicle-user interfaces can also be utilized, as the interfaces of FIG. 1 are only an example of one particular implementation. The external camera (s) 61 can be part of a forward camera module (FCM) installed on the front bumper fascia of the vehicle 12 or at the externally facing side of the vehicle's rearview mirror or one of the sideview mirrors. The external camera(s) 61 can also be positioned to view the locations out front of the vehicle 12. In addition, the one or more external cameras 61 can be operative to capture an image of a field of view (FOV) which may include static and dynamic objects proximate to the vehicle (e.g., one or more target vehicles). The lidar 63 can be installed on the front bumper fascia or roof of vehicle 12. Lidar 63 may be employed to detect objects and provide a range to and orientation of those objects using reflections from the objects providing multiple scan points that combine as a point cluster range map. For example, lidar 63 can generate a laser beam, transmit the laser beam into the FOV and capture energy reflected from a target. Lidar 63 may also employ time-of-flight to determine the distance of objects from which the pulsed laser beams are reflected

### Adaptive Cruise Control

To carry out the adaptive cruise control feature, discussed above, telematics unit 30 can use sensor and module outputs (e.g., the one or more external cameras 61, lidar 63, SRWC circuitry 32, GNSS receiver 22, etc.) capable of identifying vehicle location, locating roadway markers, proximate vehicles, and other external objects. Known sensor fusion algorithms (e.g., stored in memory 38) provides accurate tracking of external objects as well as calculation of appropriate attributes such as relative velocities, accelerations, and the like. Known image processing techniques may be used to identify, locate, and monitor objects within the FOV from the external camera(s) 61 (e.g., target vehicle 99). The identification, location, and monitoring of these objects and the surrounding environment may facilitate the creation of a three dimensional (3D) object map (which may include depth map characteristics) in order to control the vehicle in the changing environment. This object map and its various features and topographies may also at least temporarily be stored to memory 38.

When one or more of the objects within the object map is determined to be a target vehicle 99, telematics unit 30 can then be operative to receive a data from this vehicle via SRWC circuitry 32 indicative of the vehicle's location and movement characteristics (i.e., V2V data). Moreover, telematics unit 30 may generate control signals for coupling to other vehicle system modules, such as the throttle controller, brake controller and steering controller VSMs 28 in order to control certain operational aspects of the vehicle in response to the image processing techniques and/or sensor fusion algorithms and/or V2V data in response to a sensor or module output. Telematics unit 30 may be operative to adjust the speed of the vehicle by reducing or increasing the throttle via the throttle controller 28 or to apply or release the friction brakes via the brake controller 28 in response to the image processing techniques and/or sensor fusion algorithms and/or V2V data in response to a sensor or module output. Telematics unit 30 may also be operative to adjust the direction of the vehicle controlling the vehicle steering via the steering controller 28 in response to the image processing techniques and/or sensor fusion algorithms and/or V2V data in response to a sensor or module output.

### Method

The method or parts thereof can be implemented in a computer program product (e.g., telematics unit 30, etc.) embodied in a computer readable medium and including instructions usable by one or more processors of one or more computers of one or more systems to cause the system(s) to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

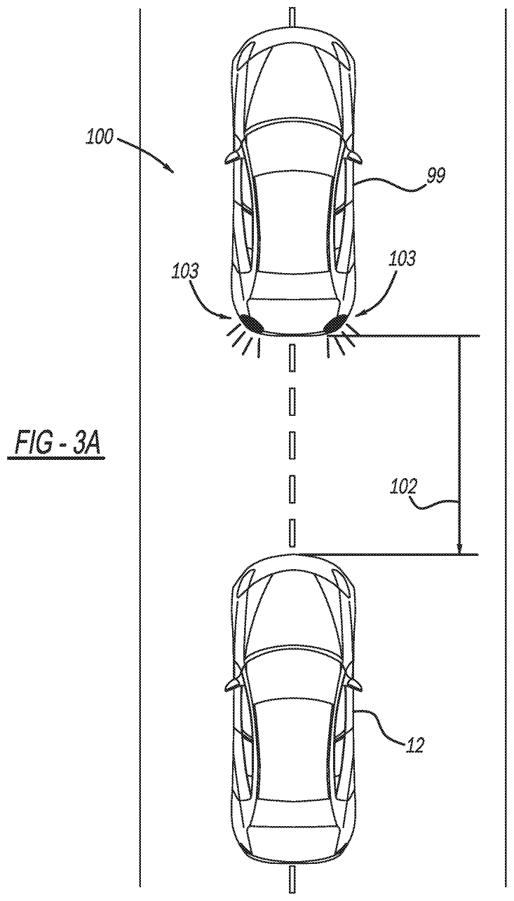

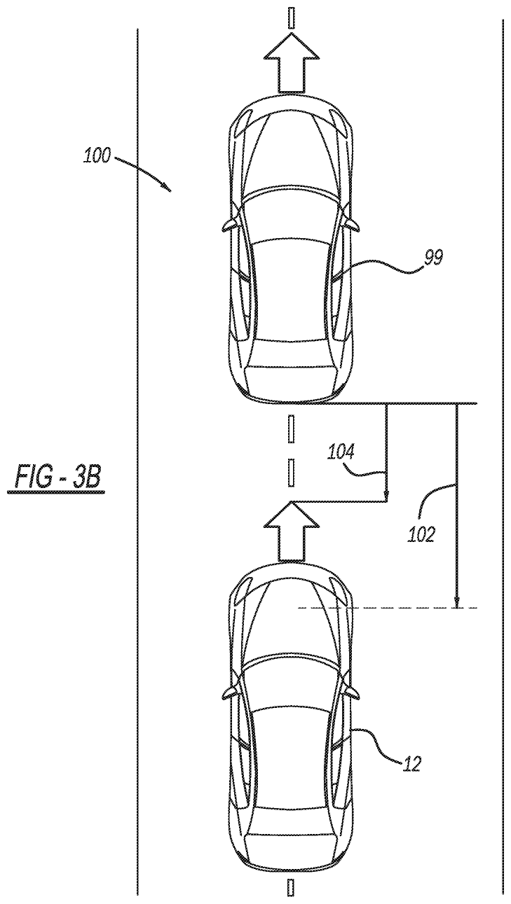

Method 200 begins at 201 in which the vehicle 12 (host vehicle) is moving at driver-selected rate of speed (discussed below) along a route while the adaptive cruise control feature is activated and assisting in vehicle operation. In step 210, with additional reference to FIG. 3A, using the sensor and module outputs, a target vehicle 99 (i.e., a third-party vehicle) is detected as being stopped at a location along the route 100. In step 220, both the brake and throttle controllers will be activated to cause the vehicle 12 to decelerate and then comfortably stop at a first distance 102, for example, four (4) meters, behind the target vehicle 99. It should be understood, this first distance can also be considered a predetermined gap distance. Moreover, in the instance that vehicle 12 incorporates a start-stop system, upon the vehicle coming to a complete stop, the vehicle's engine will at least temporarily be transitioned to an inactive state. As follows, the vehicle's engine will be powered down (via a signal from the telematics unit 30) while other vehicle operations will remain in effect. In step 230, using the output from the one or more camera(s) 61 and/or lidar 63, sensor fusion algorithms and/or image processing techniques are implemented to monitor the brake lights 103 of the target vehicle 99 being in the ON state. As follows, the brake lights 103 are detected as being illuminated to indicate the target vehicle 99 is in a braked state (i.e., the third-party vehicle is at a full stop along route 100). These sensor fusion algorithms and/or image processing techniques can also be implemented to monitor the position of the target vehicle 99 along route 100 and in relation to vehicle 12 as well as the target vehicle's 99 velocity characteristics.

In step 240, the brake lights 103 are continued to be monitored. Moreover, in this step, it is determined whether the brake lights 103 are detected to transition to an OFF state. As follows, it is determined whether the brake lights 103 have ceased being illuminated so as to indicate the target vehicle 99 is beginning to move again (i.e., the third-party vehicle is relaunching its movement along route 100). Moreover, if the brake lights 103 are monitored to remain in the ON state, then method 200 will move to step 250. Otherwise, when the brake lights 103 are determined to have transitioned to the OFF state, method 200 will move to step 260. In step 250, sensor fusion algorithms and/or image processing techniques can again be implemented to monitor the position of the target vehicle 99 along route 100 and in relation to vehicle 12 as well as the target vehicle's 99 velocity characteristics (if any). In addition or alternatively, V2V data will be received from target vehicle 99 that provides the vehicle's location and movement characteristics. Thus, this information will provide a second reference point of the target vehicle's position. The outcome from the sensor fusion algorithms and/or image processing techniques and/or V2V data (i.e., the second reference point) can then be compared and/or contrasted against the outcome from these techniques and/or data monitored in step 230 (i.e., the first reference point) to additionally verify the existence of target vehicle 99 movement (i.e., verifying a location and any changes of the target vehicle 99 location in relation to the location of vehicle 12). If the compared and/or contrasted outcomes (reference points) indicate that the third-part vehicle 99 has not moved and/or is not moving, then method 200 will return to step 240 (i.e., where the brake lights 103 will continue to be monitored). However, if the compared and/or contrasted outcomes indicate that the target vehicle 99 is moving (which could happen, for example, when the target vehicle's brake lights 103 are at least partially inoperable), then method 200 will move to step 260.

In step 260, in the instance that vehicle 12 incorporates a start-stop system, the vehicle's engine will be returned to an active state. As follows, the engine will be powered back up. In addition, or alternatively, with additional reference to FIG. 3B, the brake and throttle controllers will be activated to cause the vehicle 12 (host vehicle) to slightly accelerate for a moment and then move at a slow, steady speed in the direction of the target vehicle 99. As follows, the brake and throttle controllers will enable the vehicle's power train system to provide the maximum torque value needed to allow the vehicle 12 to creep towards the target vehicle 99. Vehicle creep (otherwise known as “idle creep” or “idle speed”) is considered the default speed that a vehicle with an automatic transmission will move when the vehicle is put into the drive gear (or reverse gear) while the brakes are released. In addition, when the vehicle 12 creeps forward it will, for example, move at a speed of five (5) miles per hour (mph) or less.

In step 270, based on the sensor fusion algorithms and/or image processing techniques and/or V2V data, it will be determined whether vehicle 12 (while creeping forward) has arrived at a second distance 104 or has crossed over the line of this second distance 104 behind the target vehicle 99. The second distance 104 can, for example, be two meters away from target vehicle 99. In addition, in this step, based on the sensor fusion algorithms and/or image processing techniques and/or V2V data, it will be determined whether there is a substantial distance between target vehicle 99 and vehicle 12 (e.g., greater than 10 meters) such that it is improbable vehicle 12 will arrive at the second distance 104. If it is determined that vehicle 12 is more than the second distance 104 away from target vehicle 99 (e.g., vehicle 12 is more than two meters away from the rear end of target vehicle 99) but there is still a sufficient probably that vehicle 12 can arrive at the second distance 104 (e.g., the vehicle distance is more than two meters but still within ten meters), then method 200 will return to step 260 (i.e., where vehicle 12 will continue to creep forward). When it is determined that vehicle 12 has arrived at the second distance 104 or vehicle 12 is less than this second distance 104 away from host vehicle 99 (e.g., vehicle 12 is two meters away from the rear end of target vehicle 99 or vehicle 12 is less than two meters away from the rear end of target vehicle 99), method 200 moves to step 280. When it is determined that it is improbable vehicle 12 will arrive at the second distance 104 (e.g., vehicle 12 is beyond ten meters from the rear end of target vehicle 99), then method 200 will move to completion 202.

In step 280, the brake and throttle controllers will be activated to cause vehicle 12 to come to a complete stop (which may be abrupt but still comfortable for the vehicle occupants due to the creep movement of vehicle 12 being five mph or less). In the instance that vehicle 12 incorporates a start-stop system, the vehicle's engine can subsequently be at least temporarily turned to an inactive state. After step 280, method 200 moves to completion 202.

Upon completion 202, default adaptive cruise control functionality recommences such that sensor fusion algorithms and/or image processing techniques and/or V2V data is/are used in a typical fashion, for example, to detect one or more third-party vehicles (or some other third-party vehicle) along the trajectory of vehicle 12. For example, when target vehicle 99 again comes to a halt in front of vehicle 12 (which may be due to traffic along route 100). Moreover, when default adaptive cruise control functionality recommences, the vehicle will relaunch and begin to move again at a driver-selected rate of speed along route 100 (i.e., the vehicle 12 will travel at the rate of speed that has been preset by the vehicle operator, which may be via one or more virtual buttons provided on display 50). It should be understood that the driver-selected rate of speed will be governed by the adaptive cruise control functionality and should be in compliance with localized traffic laws along route 100 (e.g., the vehicle should be preset by the vehicle's operator to move 55 mph along a route 100 having a 55 mph speed limit). Alternatively or additionally, when vehicle 12 detects that it has been stopped behind target vehicle 12, due to insufficient movement of target vehicle 99 (e.g., target vehicle 99 has been stopped for more than 30 seconds due to being broken down or having its engine in an inactive state), vehicle 12 will designate target vehicle 99 as being in an inactive state. As a result, the logic to commence vehicle movement upon being stopped behind target vehicle 99 (i.e., method 200) will be at least temporarily halted for target vehicle 99 only. Thus, upon vehicle 12 moving out from being behind target vehicle 99 and recommencing adaptive cruise control functionality to move along route 100, vehicle 12 will restart method 200 when it encounters other third-party vehicles (not shown) that are not target vehicle 99. It should be understood that the target vehicle designation (e.g., a virtual tag) can be provided within the object map and at least temporarily stored to memory 38.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A system to commence host vehicle movement upon being stopped behind a target vehicle, the system comprises:
a memory configured to comprise one or more executable instructions and a processor configured to execute the executable instructions, wherein the executable instructions enable the processor to:
detect the target vehicle as being stopped along a route;
cause the host vehicle to stop at a first distance from the target vehicle;
detect a transition of one or more brake lights of the target vehicle from an ON state to an OFF state; and
after the one or more brake lights are detected to transition from the ON state to the OFF state, cause the host vehicle to move at a slow speed in the direction of the target vehicle.

2. The system of claim 1, wherein the transition of the one or more brake lights of the target vehicle from the ON state to the OFF state is detected based on an output from one or more cameras installed on the host vehicle.

3. The system of claim 1, wherein the executable instructions further enable the processor to:
before the one or more brake lights are detected to transition from the ON state to the OFF state, verify a location of the target vehicle in relation to the location of the host vehicle; and
based on the verification of the target vehicle location, cause the host vehicle to move at a slow speed in the direction of the target vehicle.

4. The system of claim 1, wherein the executable instructions further enable the processor to:
before the one or more brake lights are detected to transition from the ON state to the OFF state, transition an engine of the host vehicle to an inactive state.

5. The system of claim 1, wherein the executable instructions further enable the processor to:
after the one or more brake lights are detected to transition from the ON state to the OFF state, transition an engine of the host vehicle to an active state.

6. The system of claim 1, wherein the executable instructions further enable the processor to:
while the host vehicle moves at the slow speed, determine whether the host vehicle has arrived at a second distance from the target vehicle; and
when the host vehicle is determined to have arrived at the second distance, cause the host vehicle to stop moving at the slow speed.

7. The system of claim 6, wherein the executable instructions further enable the processor to:
when the host vehicle is determined to be beyond the second distance from the target vehicle, determine whether it is improbable the host vehicle will arrive at the second distance; and
when it is determined to be improbable the host vehicle will arrive at the second distance, commence vehicle movement at a driver-selected rate of speed.

8. A method to commence host vehicle movement upon being stopped behind a target vehicle, the method comprising:
detecting the target vehicle as being stopped along a route;
causing the host vehicle to stop at a first distance from the target vehicle;
detecting a transition of one or more brake lights of the target vehicle from an ON state to an OFF state; and
after the one or more brake lights are detected to transition from the ON state to the OFF state, causing the host vehicle to move at a slow rate of speed in the direction of the target vehicle.

9. The method of claim 8, wherein the transition of the one or more brake lights of the target vehicle from the ON state to the OFF state is detected based on an output from one or more cameras installed on the host vehicle.

10. The method of claim 8, further comprising:
before the one or more brake lights are detected to transition from the ON state to the OFF state, verifying a location of the target vehicle in relation to the location of the host vehicle; and
based on the verification of the target vehicle location, causing the host vehicle to move at a slow rate of speed in the direction of the target vehicle.

11. The method of claim 8, further comprising:
before the one or more brake lights are detected to transition from the ON state to the OFF state, transitioning an engine of the host vehicle to an inactive state.

12. The method of claim 8, further comprising:
after the one or more brake lights are detected to transition from the ON state to the OFF state, transitioning an engine of the host vehicle to an active state.

13. The method of claim 8, further comprising:
while the host vehicle moves at the slow rate of speed, determining whether the host vehicle has arrived at a second distance from the target vehicle; and
when the host vehicle is determined to have arrived at the second distance, causing the host vehicle to stop moving at the slow rate of speed.

14. The method of claim 13, further comprising:
when the host vehicle is determined to be beyond the second distance from the target vehicle, determining whether it is improbable the host vehicle will arrive at the second distance; and
when it is determined to be improbable for the host vehicle to arrive at the second distance, commencing vehicle movement at a driver-selected rate of speed.

15. A non-transitory machine-readable medium having stored thereon executable instructions adapted to commence host vehicle movement upon being stopped behind a target vehicle, which when provided to a processor and executed thereby, causes the processor to:
detect the target vehicle as being stopped along a route;
cause the host vehicle to stop at a first distance from the target vehicle;
detect a transition of one or more brake lights of the target vehicle from an ON state to an OFF state; and
after the one or more brake lights are detected to transition from the ON state to the OFF state, cause the host vehicle to move at a slow rate of speed in the direction of the target vehicle.

16. The non-transitory machine-readable medium of claim 15, further comprising:
before the one or more brake lights are detected to transition from the ON state to the OFF state, verify a location of the target vehicle in relation to the location of the host vehicle; and
based on the verification of the target vehicle location, cause the host vehicle to move at a slow rate of speed in the direction of the target vehicle.

17. The non-transitory machine-readable medium of claim 15, further comprising:
before the one or more brake lights are detected to transition from the ON state to the OFF state, transition an engine of the host vehicle to an inactive state.

18. The non-transitory machine-readable medium of claim 15, further comprising:
after the one or more brake lights are detected to transition from the ON state to the OFF state, transition an engine of the host vehicle to an active state.

19. The non-transitory machine-readable medium of claim 15, further comprising:
while the host vehicle moves at the slow rate of speed, determine whether the host vehicle has arrived at a second distance from the target vehicle; and
when the host vehicle is determined to have arrived at the second distance, cause the host vehicle to stop moving at the slow rate of speed.

20. The non-transitory machine-readable medium of claim 19, further comprising:
when the host vehicle is determined to be beyond the second distance from the target vehicle, determine whether it is improbable the host vehicle will arrive at the second distance; and
when it is determined to be improbable the host vehicle will arrive at the second distance, commence vehicle movement at a driver-selected rate of speed.
